(19) United States
(12) Patent Application Publication
(10) Pub. No.: US 2024/0290006 A1
(43) Pub. Date: Aug. 29, 2024

(54) SYSTEMS AND METHODS FOR DISPLAYING A COATING

(71) Applicant: AXALTA COATING SYSTEMS IP CO., LLC, Wilmington, DE (US)

(72) Inventor: Daniel A. Benton, Wilmington, DE (US)

(73) Assignee: AXALTA COATING SYSTEMS IP CO., LLC, Wilmington, DE (US)

(21) Appl. No.: 18/440,220

(22) Filed: Feb. 13, 2024

Related U.S. Application Data
(60) Provisional application No. 63/487,430, filed on Feb. 28, 2023.

(51) Int. Cl. G06T 11/00

(52) U.S. Cl. CPC G06T 11/001

(57) ABSTRACT

Methods and systems for displaying a modified coating image are provided. In an exemplary embodiment, a method of displaying a coating includes a person entering a starting coating into a computer with an input device, where the computer includes the input device, a memory, a processor, and an output device. The computer provides a starting color additive formulation for the starting coating, where the starting color additive formulation includes a starting color additive and a starting color additive quantity. The person enters a modified color additive formulation into the computer, where the modified color additive formulation is different than the starting color additive formulation. The computer generates a modified coating image based on the modified color additive formulation, and displays the modified coating image on the output device.

This application claims the benefit of U.S. Provisional Application No. 63/487,430, filed Feb. 28, 2023, which is hereby incorporated in its entirety by reference.

### TECHNICAL FIELD

The technical field is directed to methods and systems for displaying a coating, and more particularly to methods and systems for displaying modifications to the appearance of a coating based on color additive formulation changes.

### BACKGROUND

Surface coatings such as monocoat, clearcoat/colorcoat, and tricoat are favored for the protection and decoration of substrates such as vehicle bodies. The surface coatings can utilize one or more pigments or effect pigments to impart the desired color or appearance, such as solid, metallic, pearlescent effect, gloss, or distinctness of image, to the vehicle bodies. Metallic flakes, such as aluminum flakes and pearlescent flakes are commonly used to produce coatings having flake appearances such as texture, sparkle, glint and glitter as well as the enhancement of depth perception in the coatings imparted by the flakes.

A small difference in the coloration of a motor vehicle coating, or of other items, may be quite apparent to viewers. Also, effect pigments may be in the original coating that provide specialized effects, such as “flop” when the color or appearance of a vehicle changes depending on viewing angle. Effect pigments may also provide a pearlescence appearance, sparkle, etc. The appearance of a coating may change over time, due to fading, and there may be differences in coating batches of the same type from one location to another, or from one time to another. Therefore, even if a known coating type and color can be identified for a specific vehicle, the exact appearance may be different than that for a fresh batch of the same coating type and color.

In this description, reference is made to coloration of a motor vehicle, but it is to be understood that the systems and methods described herein may be applied to other articles as well. The color of the original, target coating can be measured, but the presence of effect pigments, such as interference effect pigments and reflective flakes, can make matching the overall appearance of the target coating challenging. Furthermore, some repair facilities do not have the measurement devices and equipment for automated color matching. Also, some repair personnel feel more comfortable using old tried-and-true color matching techniques, such as a fan deck that provides the appearance of some coatings.

Many repair facilities will use a fan deck to match coatings, where the fan deck includes a variety of sample cards from different coatings and/or coating colors. The repair technician holds up various sample cards to the vehicle to be repaired, and selects the sample card that most closely matches the vehicle. However, due to the factors mentioned above, or due to other factors, the fan deck may not include an exact match for the vehicle.

As such, it is desirable to find a method or system to match coatings when a fan deck color does not exactly match the actual color on the vehicle. In addition, it is desirable to find a method to modify a given coating color to more closely match a vehicle, where the modifications can be viewed without the need to prepare and apply an actual sample coating for viewing and comparison.

### SUMMARY

Methods and systems for displaying a modified coating image are provided. In an exemplary embodiment, a method of displaying a coating includes a person entering a starting coating into a computer with an input device, where the computer includes the input device, a memory, a processor, and an output device. The computer provides a starting color additive formulation for the starting coating, where the starting color additive formulation includes a starting color additive and a starting color additive quantity. The method further includes the person entering a modified color additive formulation into the computer, where the modified color additive formulation is different than the starting color additive formulation. The computer generates a modified coating image based on the modified color additive formulation, and displays the modified coating image on the output device.

A system for displaying a modified coating image is provided in another embodiment. The system includes a computer, where the computer has a processor, an input device, an output device, and a tangible memory. A computer program is stored on a tangible memory device, and the processor operates the computer program. The computer program is configured to accept a starting coating from the input device, and provide a starting color additive formulation that is associated with the starting coating. The starting color additive formulation includes a starting color additive and a starting color additive quantity. The computer program accepts a modified color additive formulation from the input device, where the modified color additive formulation is different than the starting color additive formulation. The computer program generates a modified coating image based on the modified color additive formulation, and displays the modified coating image on the output device.

Another method of displaying a modified coating image is provided in yet another embodiment. The method includes providing a starting coating list by a computer, where the computer includes a processor, an input device, a memory, and an output device. A person chooses a starting coating from the starting coating list, and enters the starting coating into the computer with the input device. The input device is selected from the group consisting of a keyboard, a mouse, a touchscreen, a microphone, and combinations thereof. The computer provides a starting color additive formulation for the starting coating, where the starting color additive formulation includes a starting color additive and a starting color additive quantity. A modified color additive formulation is entered into the computer with the input device, where the modified color additive formulation is different than the starting color additive formulation. The computer retrieves a starting coating image that corresponds to the starting coating, and generates a modified coating image based on the modified color additive formulation. The starting coating image and the modified coating image are displayed on the output device in three dimensions.

### BRIEF DESCRIPTION OF THE DRAWINGS

The present embodiments will hereinafter be described in conjunction with the following drawing figures, wherein like numerals denote like elements, and wherein:

FIG. 1 is schematic representing an embodiment of a computer system;

FIG. 2 is a flowchart of an embodiment of a method for displaying the coating;

FIG. 3 is an embodiment of a coating display.

FIG. 4 in another embodiment of a coating display.

FIG. 5 is a flowchart of an embodiment that supplements the flowchart in FIG. 2; and

FIG. 6 is a display of a vehicle in a partitioned view, including a selection of a component to be coated.

### DETAILED DESCRIPTION

The following detailed description is not intended to limit this description or the application and uses thereof. Furthermore, there is no intention to be bound by any theory presented in the preceding background or the following detailed description. It should be understood that throughout the drawings, corresponding reference numerals indicate like or corresponding parts and features.

In simple terms, the disclosure presents a method and system for modifying the appearance of a coating. In short, the method includes a person determining a close match to a given color and appearance of a coating, where that close but still imperfect match is referred to as the starting coating. In general, the starting coating is a cured coating on an article that the person wants to match. The person then provides suggested modifications to the color additive formulation used to produce the color and appearance of the coating, where the theoretical coating is referred to herein as the modified coating. The theoretical modified coating is also a cured coating, as opposed to an uncured coating composition, because the person desired cured coatings to match. A computer generates the color and appearance of the modified coating that would be produced by the suggested modifications to the color additive formulation, and provides an image of the modified coating, where that image may be presented adjacent to an image of the starting coating. The person may then try different modification to the color additive formulation in additional attempts to exactly match the color and appearance of the vehicle, such that the need to repeatedly produce trial coatings with various color additive formulations for matching an actual vehicle can be reduced or eliminated.

In general, a company may provide several different types of coatings, and each type of coating may be provided in several different color options. For example, a company may produce a polyurethane coating composition in an aqueous solvent as one type of coating composition, a polyurethane coating composition in organic solvents as another type of coating composition, an acrylic coating in aqueous and organic solvent as two other types of coating compositions, etc. Each coating composition may be colored by one or more color additives. As used herein, a “color additive” is a dye, pigment, effect pigment, effect additive, or other component added to an uncured coating composition for the purpose of changing the color or appearance of the resulting cured coating. The one or more color additives that are added to the uncured coating composition form a color additive formulation for the coating, such that the color and appearance of the cured coating is largely determined by the color additive formulation used in the uncured coating composition. The color additive formulation includes each color additive used in the uncured coating composition, as well as the concentration of that color additive in the uncured coating composition. In this description, it is generally assumed that a standard quantity of uncured coating composition is colored by the color additive formulation, so the concentration of the color additive in the color additive formulation is often referred to as a “quantity” of color additive because that quantity is used in a known, standard quantity of the uncured coating composition. As such, the quantity of color additive in a standard amount of uncured coating composition provides a concentration of the color additive.

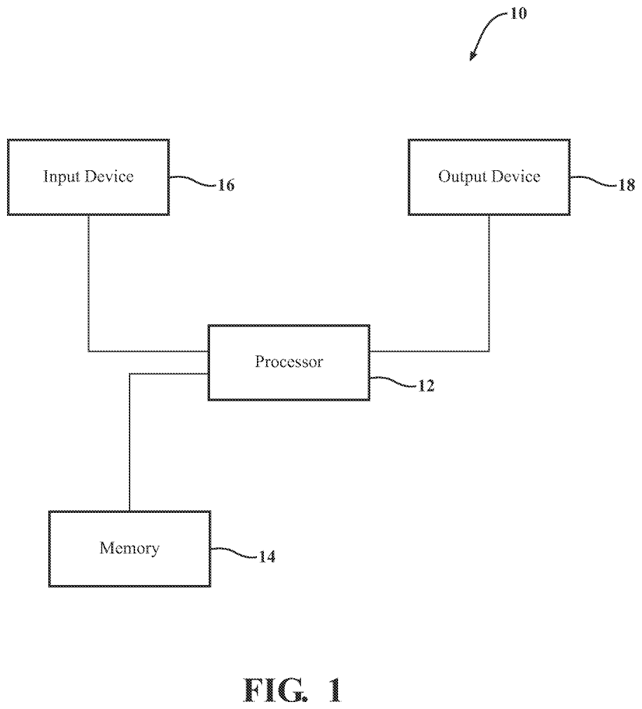

The methods and systems used and described herein utilize a computer 10 in a system, as generally shown in FIG. 1. The computer 10 may perform various techniques and technologies that may be described herein in terms of functional and/or logical block components, and functions that may be performed by various computing components or devices. In practice, the computer 10 includes one or more processors 12 that carry out the described operations, tasks, and functions by manipulating electrical signals representing data bits at memory locations in the system memory 14, as well as other processing of signals. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

The computer 10 also includes an input device 16 and an output device 18. The input device 16 is configured for a human being, i.e. a person, to enter data, instructions, or other communications to the computer 10, and the output device 18 is configured for the computer 10 to provide data, images, instructions, etc. to the person. In an exemplary embodiment, the input device 16 may be selected from a group consisting of a keyboard, a mouse, a touchscreen, a microphone, and a combination thereof. The mouse may be used to direct a pointer to a position on a screen, and then select something by clicking or otherwise indicating a selection while pointing at the icon where the pointer is positioned. The microphone may be used for receiving verbal messages, where the verbal messages are converted to a form identifiable for the computer. In alternate embodiments, the input device 16 may be any type of input device 16 used with computers 10, such as those mentioned above, as well as electronic links to other computers or electronic devices. For example, the input device may be a connection, either wired, wireless, or otherwise connected such that communication is possible, to a telephone, a camera, or another computer. A modem is one type of device that may operate as the input device 16, the output device 18, or both.

The output device 18 may include a screen that can be viewed by a person, as well as a printer, etc. In an exemplary embodiment, the output device 18 is selected from the group consisting of a screen, a printer, and a combination thereof. A printer may provide a portable image printed on a piece of paper that can be carried to a vehicle for repair and compared directly with the cured vehicle coating. However, in alternate embodiments, the output device 18 may be any output device 18 used with computers 10. This includes the screen and printer mentioned above, but is not limited to these specific types of output devices 18. Other alternate output devices may include a wired, wireless, or other connection such that communication is possible to a telephone, a cell phone, a computer, a camera, a robot, a tablet, or other electronic devices. The descriptions mentioned above for an input and/or output device 16, 18 that is limited to the specifically named components means that the specifically named components are those utilized by the computer 10 for the methods and systems disclosed herein, despite the fact that the computer 10 may include additional input and/or output devices that are not utilized by the methods or systems described herein.

The computer 10 includes a computer program that is stored on a tangible memory device, such as a computer hard drive, a compact disc, a DVD, a flash memory device such as a USB drive or SD card, or a combination thereof, wherein the tangible memory device may be the memory 14 discussed above. Any other tangible computer readable storage medium may be suitable. The computer program is operated by the processor 12, where the processor 12 may access the computer program from a local hard drive. However, in alternate embodiments, the processor 12 may access the computer program remotely, and the computer program is saved on a tangible memory device remote from the computer 10. However, the computer program is saved on a tangible memory device somewhere in all embodiments, where the tangible memory device may be the local memory 14 on the computer 10 or a different tangible memory device. The memory 14 is also stored on a tangible memory device, but may be accessed by the computer program and/or processor through communication lines that are not tangible. For example, the memory may be saved on a hard disc, and remotely accessed by the computer 10 at a work location, such as access through the “cloud.” The computer program is configured to facilitate entry of data by the person, as described herein. The computer program is also configured to facilitate presenting data to the person as described herein.

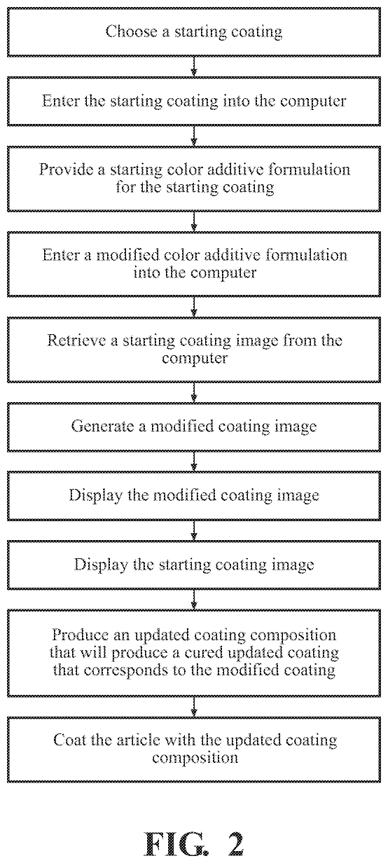

The system and method rely on a combination of human actions and computer actions. Referring to FIG. 2 with continuing reference to FIG. 1, the method generally comprises one or more of the following steps, where the steps may be performed in an order different than as listed below:
1. chose a starting coating 100;
2. enter the starting coating into a computer 110;
3. provide a starting color additive formulation for the starting coating 120;
4. enter a modified color additive formulation into the computer 130;
5. retrieve a starting coating image 140;
6. generate a modified coating image 150;
7. display the modified coating image 160;
8. display the starting coating image 170;
9. produce an updated coating composition that will produce a cured updated coating that corresponds to the modified coating 180; and
10. coat the article with the updated coating composition 190.

The starting coating is chosen in step 100, where a person selects the starting coating. The starting coating is a cured coating, because the desired appearance is based on the cured coating. In general, the memory 14 includes a starting coating list of existing coatings that have been offered by a coating manufacturer, where the starting coating list is taken from the list of existing coatings that have been offered. The starting coating list includes the type of coating, as well as the color additive formulation, for the coatings that have been offered. Manufacturer records are utilized for the specific details of the starting coating list. The computer program accesses the memory 14 for the starting coating list.

The process of choosing the starting coating may be performed in a variety of manners. For example, a person may use a fan deck to choose the starting coating. A fan deck is a collection of cards that have the color of a coating provided by a coating provider. Manufacturers generally offer a type of coating, such as a water-based polyurethane coating composition, in a variety of colors for the user to select the color, as mentioned above. The fan deck may include a plurality of cards, where each card has a surface that displays one of the colors and appearances available for a specific type of coating. There may be a plurality of fan decks for a single type of coating, where the colors of the fan deck are categorized. For example, there may be a fan deck showing various shades or effects with blue, and another fan deck for green, yet another for red, etc. The person selects a card from the fan deck that is as close as possible to the color on the vehicle, and that becomes the starting coating. The coatings provided by the fan deck are generally coatings that are on the starting coating list.

In another embodiment, the person determines the make, model, and year of the vehicle to be repaired, where the vehicle to be repaired is referred to as the target motor vehicle. An Original Equipment Manufacturer (OEM) coating type and an OEM coating color is then determined for the target motor vehicle, where the OEM coating type and color are for the cured coating. A vehicle manufacturer (i.e., an OEM) will generally use a type of coating for a vehicle model, and a limited number of colors are produced to control the inventory for that vehicle model. The OEM coating may change for different makes (i.e., manufacturers), models, and model years, so the target motor vehicle is often identified by the make, model, and year of the vehicle. The trim of the vehicle may also be used in identifying the target motor vehicle. The OEM coating type for the target motor vehicle may be provided by the computer 10, or otherwise determined by the person. For example, the person may have other references that identify the OEM coating type for the target motor vehicle. The computer 10 may then provide an OEM coating color list associated with the target motor vehicle. The person may then choose the starting coating 100, which includes the coating type and the coating color, for the target motor vehicle from the OEM coating color list. The starting coating includes the starting color additive formulation that primarily produces the appearance of the starting coating.

In yet another embodiment, the person may use an imaging device to identify the starting coating. There are existing imaging systems that can identify a coating type and color, and the user may use one of these imaging systems to choose the starting coating. These imaging systems typically use several various techniques for determining the color and appearance of a coating, where the color is determined by color data. The term “color data” or “color characteristics” of a coating can comprise measured color data including spectral reflectance values; X, Y, Z values; L*, a*, b* values where L* indicates lightness, a* indicates color from green (−) to red (+), and b* indicates color from blue (−) to yellow (+); L*,C*,h* values where L* indicates lightness, C* indicates chroma, and h* indicates hue; a flop index; or a combination thereof. Additional appearance characteristics can also be quantified, such as pearlescence, sparkle, etc. Color data can further include a color code of a vehicle, a color name or description, or a combination thereof. The color data can be obtained by visual inspection, or by using an imaging device such as a colorimeter, a spectrophotometer, or a gonio spectrophotometer. In particular, spectrophotometers obtain color data by determining the amount of light reflected at each wavelength by a coating layer. The color data can also include descriptive data, such as a name of a color, a color code of a vehicle; a binary, textural or encrypted data file containing descriptive data for one or more colors; a measurement data file, such as those generated by a color measuring device; or an export/import data file generated by a computing device or a color measuring device. Color data can also be generated by a color-appearance dual measuring device. In many cases, the color data is determined as a plurality of viewing angles, where a viewing angle represents the angle of a view relative to a surface with a fixed, known lighting position. The color data may be determined at 1, 2, 3, or more viewing angles in various embodiments. Exemplary viewing angels are 15°, 25°, 45°, 75°, 90°, and 110°, but other viewing angles may be used in alternate embodiments.

Once the person choses a starting coating 100, the starting coating is entered into the computer 110 with the input device 16, and the computer 10 accepts the starting coating. This may be done in a variety of manners. For example, the person may enter an identification number associated with the starting coating. This identification number may be provided by the card in the fan deck, or by the computer for the OEM color, or by the imaging device system utilized, or by other methods. Alternatively, the person may enter a color name that identifies the color, where the color name may be provided as described above for the identification number. The person may type the color identifier into the computer, or may select the color identifier from a list provided by the computer using a mouse or touchscreen.

After receiving and accepting the starting coating from the person, the computer 10 provides a starting color additive formulation 120 for the starting coating. The starting color additive formulation is a list of color additives that are present in the starting coating, and the quantity of each of the color additives in the starting coating. It is understood that the quantity of the color additive is in reference to a known quantity of the coating composition as produced before curing, where that uncured coating composition is cured to produce the cured coating. The composition and curing of the uncured coating composition is consistent, so the uncured coating composition produces a cured coating with consistent appearance characteristics, as well as with consistent quantities of the color additives that were present in the uncured coating composition. Therefore, the quantity of starting color additive does provide a concentration of the starting color additive in the starting coating, which is a cured coating, as mentioned above. In an exemplary embodiment, the processor 12 of the computer accesses the memory 14 to retrieve the starting color additive formulation for the starting coating, and the starting color additive formulation is displayed for the person on the output device 18.

After viewing the starting color additive formulation, the person decides on a change to the starting color additive formulation. The appearance of the starting coating changes over time, due to fading, wear, etc., and so the starting color additive formulation may need to be modified for a perfect match to an aged motor vehicle to account for these gradual changes in appearance, as mentioned above. The person decides that the starting color additive formulation is not a perfect match, so the person wants to find a modification to the starting color additive formulation that will be a better match. Usually, the starting color additive formulation will be close to a perfect match, so it makes sense to use the starting color additive formulation as a starting point in efforts to find the perfect match. As such, the person changes one or more of the color additives in the starting color additive formulation, where that change may be in the amount of one of the color additives used in the starting color additive formulation, or it may be a change in a dye, pigment, or other color additive. For example, the person may decide to add a new dye, or to remove a dye, from the starting color additive formulation in an effort to produce a better match.

The person enters a different color additive formulation into the computer 10 with the input device 16, where that different color additive formulation is referred to as the modified color additive formulation 130. The computer 10 accepts the modified color additive formulation from the person by way of the input device 16. The modified color additive formulation corresponds to a hypothetical modified coating that includes the modified color additive formulation. The hypothetical modified coating is a cured coating that would result from an uncured modified coating composition using the modified color additive formulation, where the appearance of the cured hypothetical modified coating depends in large part on the modified color additive formulation added to the uncured coating composition. The modified color additive formulation is different from the starting color additive formulation in one or more color additives or color additive quantities, and the different color additive (or different color additive quantity) is referred to as the updated color additive. For example, the person may think the starting coating has a color that is not quite blue enough, so the person may increase the amount of a blue pigment for the modified color additive formulation. As such, the modified color additive formulation may include the updated color additive that is selected from the starting color additive formulation, but where an updated color additive quantity is different than the starting color additive quantity for at least one of the starting color additives. Alternatively, the starting color additive formulation may not include the blue pigment the person wants to add, so the person may add a blue pigment that is not present in the starting color additive formulation to form the modified color additive formulation. In another alternative, the starting color additive formulation may include a blue pigment that the person wants to remove, so that blue pigment is removed from the starting color additive formulation. The modified color additive formulation may include one or more changes from the starting color additive formulation. Listed below in Table 1 is an example of a starting color additive formulation with a modified color additive formulation, but many alternative modifications may be made in alternate embodiments.

TABLE 1

| | Starting coating | Modified coating | Difference |
|---|---|---|---|
| Color additive | quantity (grams) | quantity (grams) | (grams) |
| White HS | 101.5 | 101.5 | |
| Blue shade green | 1.2 | 1.8 | 0.6 |
| LS | | | |
| Black LS | 0.42 | 0.42 | |
| Yellow oxide | 0.38 | 0.38 | |
| Flop control | 19.7 | 19.7 | |

In an exemplary embodiment, the computer 10 includes and provides a list of additional color additives that are not in the starting color additive formulation, but are available for the modified color additive formulation, so that the person has a list of color additives that may be utilized.

The computer 10 retrieves a starting coating image 140 that corresponds to the starting coating, and the computer 10 generates a modified coating image 150 that corresponds to the modified coating. The computer 10 uses known color calculation techniques to generate the modified coating image 150.

In an exemplary embodiment, color data from test coatings are measured, and color data from the test coatings are saved to produce a library of test coatings with known test coating color additive formulations. The color data are measured on cured test coatings, because the appearance of the cured coatings is used to for matching purposes. For example, different uncured test coating compositions may be produced where the test coating color additive formulation for each of the uncured test coating compositions is different. Each uncured test coating composition is then cured to form the test coating, and the color data of each cured test coating is measured to determine the change in the color data for a known change in the test coating color additive formulation. This test coating with a different test coating color additive formulation is then saved as another test coating in the test coating library. This process can be repeated many times to develop measurable, quantifiable changes to the color data resulting from a change in the test coating color additive formulation. These changes can then be incorporated into the computer program for calculating changes in the color data for the modified color additive formulation versus the starting color additive formulation. For example, testing may show that the value of a color data point, such as the a* value, changes in a consistent manner for changes in a particular color additive. If that particular color additive is changed in quantity in the modified color additive formulation verses the starting color additive formulation, the computer may use this information to interpolate or extrapolate the a* value for the modified coating image based on the color data test results from the test coatings and the change in the modified color additive formulation. Other types of calculations are also possible, such as if the test coating measurements provide a non-linear change to a color data, or a change to more than one color data, etc. Combined changes in the color additives used can also be tested with test coatings to aid in the determination of the of the modified color image. The test coating data may be utilized to device a technique for generating the modified coating image based on the modified color additive formulation. As such, the color data for a plurality of test coatings can be utilized to support the generation of the modified color image 150.

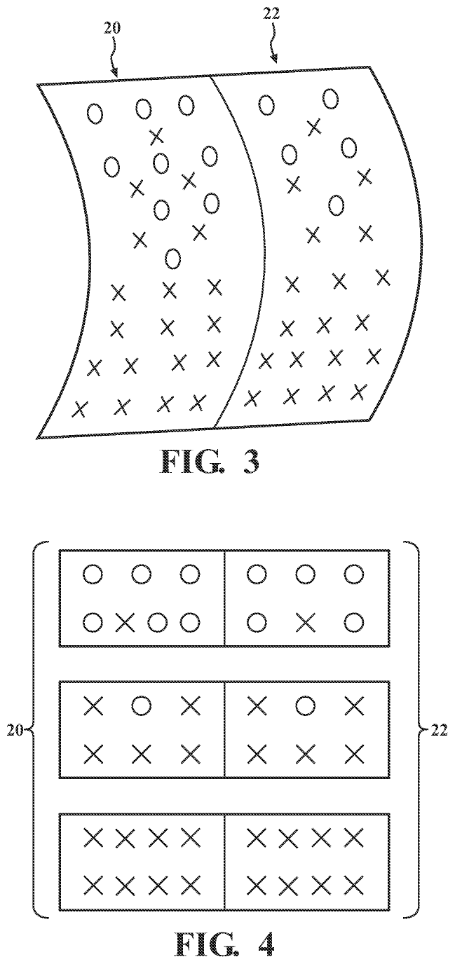

In an exemplary embodiment, the starting coating image and/or the modified coating image are displayed in a depiction of the starting coating and/or the modified coating in three dimensions. The actual display is a two dimensional device, but the image is depicted in three dimensions, and is referred to herein as a three dimensional display. Referring to FIG. 3, the starting coating image 20 and the modified coating image 22 may be presented as a curved surface in three dimensions. Alternatively, as illustrated in FIG. 4, the starting coating image 20 and the modified coating image 22 may be presented in two dimensions at a plurality of viewing angles, and the person can determine the change for viewing angles between those shown. In FIGS. 3 and 4, the symbols (x, o) represent colors, and the concentration of those symbols are intended to suggest the strength of that color in the image. The color data for a coating may be determined at select viewing angles, so the color data for a curved surface such as in FIG. 3 may be calculated based on the color data at the measured viewing angles. As illustrated, the color represented by the “x” is the same in the starting coating image and the modified coating image, but the color represented by the “o” decreases at the top of the image as the viewing angle becomes steeper near the top of the images. The color represented by the “o” decreases and disappears as the viewing angle becomes shallower at the bottom of the image, but the strength of the color represented by the “o” is weaker at the top of the modified coating image than at the top of the starting coating image, where the viewing angle is steeper. The change in the color as the viewing angle changes indicates “flop,” where the apparent color changes depending on the viewing angle.

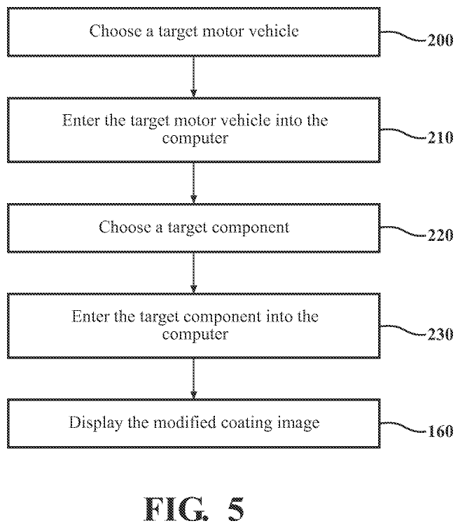

Another embodiment is illustrated by the flowchart in FIG. 5, where the flowchart in FIG. 5 supplements the flowchart in FIG. 2. The embodiment illustrated in FIG. 5 generally comprises one or more of the following steps, where the steps may be performed in an order different than as listed below:
a. Choose a target motor vehicle 200;
b. Enter the target motor vehicle into the computer 210;
c. Choose a target component 220;
d. Enter the target component into the computer 230; and
e. Display the modified coating image 160, as indicated in FIG. 2.

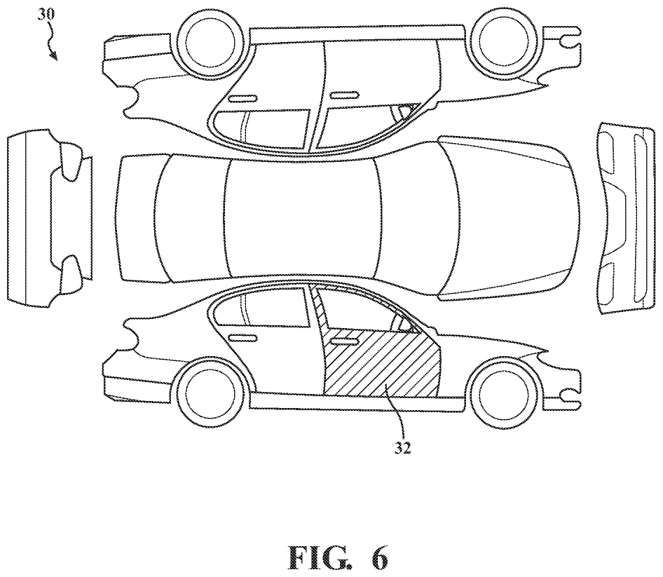

In an exemplary embodiment, the display of the modified coating and/or the starting coating is rendered in three dimensions on an actual article of a motor vehicle, such as on a door panel that is in need of repair and re-painting. In this embodiment, the person (where reference to the person herein generally may indicate the same person mentioned above, or a different human being or individual, such that 1 or more than 1 people may be involved) chooses a target motor vehicle 200, such as the motor vehicle that needs repairs. That vehicle is referred to herein as the target motor vehicle 30, and is illustrated in FIG. 6 with the various components shown in partition format. The person then enters the target motor vehicle into the computer 210 with the input device 16, and the computer accepts the target motor vehicle 30. The person then chooses a target component 200, where the target component 32 is a component of the target motor vehicle 30. That component is referred to herein as the target component 32, where the target component 32 is specific to the target motor vehicle 30. The target component 32 may be the one (or more) components that needs to be repaired. The person enters the target component into the computer 230 with the input device 16, and the computer 10 accepts that target component 32. The target component 32 may be selected by typing in the name of the component, or the computer 10 may display the target motor vehicle 30 such that the person can choose the target component 32, such as with a touch screen, a mouse, or otherwise.

In the embodiment illustrated in FIG. 6, a right front door panel is the target component 32, but the target component 32 is further identified by the target motor vehicle 30 because a right front door panel for one automobile generally has a different surface and shape than the right front door panel for another automobile. The memory 14 has a three dimensional rendering of the target component 32, such that the actual three dimensional shape is available to the computer 10 in a digital representation. The three dimensional shape of the target component 32 may be saved as a three dimensional mapping of a geometry of at least a part of a surface of the target component 32.

Reference is made to FIGS. 1-6. The computer 10 then displays the modified coating image on the three dimensional shape of the target component 32, such that the person can see that actual target component 32 with the modified coating on the target component 32. As such, the display of the modified coating image 150 is provided in a three dimensional shape, where the three dimensional shape is a three dimensional representation of the actual target component 32 that is to be repaired. This display can be useful to the person because the change in appearance of a coating at different viewing angles is presented and visible for the actual target component 32 being repaired. The user can see the modified coating as it will appear on the target component 32. The computer 10 may optionally also display the starting coating image on the target component 32, for comparison, where the starting coating image and the modified coating image may be displayed side by side, or sequentially (such as in different screens), or in other display formats.

In yet another embodiment, the person may choose a portion of the target component 32 for display, such as with a box controlled by a mouse, so the modified and/or starting coating image is displayed on the desired portion of the target component 32. This smaller display area may be useful if the person is repairing a portion of a component, and only wants to see the portion of the component being repaired.

The memory 14 has the three dimensional shape of the target component 32 saved, so the viewing angle for each pixel or section of the target component 32 can be calculated based on a point of view for the viewer. The appearance calculations can determine the appearance of the modified coating at each viewing angle, as described above, so the processor 12 can provide the appropriate appearance for each section or pixel of the target component 32. As such, changes due to varying viewing angles are displayed in the modified coating image on the target component 32, such as changes in color due to flop, changes in sparkle, pearlescence, etc.

The modified coating image 22 is displayed 160 for the person, and the starting coating image 20 may optionally be displayed 170 as well, such as illustrated in FIGS. 3 and 4, with continuing reference to FIGS. 1 and 2. Other types of display are also possible, such as an image that curves up and down (and also curves left and right). A single flat plane may be displayed, or more or fewer flat planes at more or fewer viewing angels may be displayed in alternate embodiments. Other possible display options may also be utilized, such as the target component display discussed above.

In an exemplary embodiment, the modified coating image is displayed 160 on a screen, where the display is in color. The starting coating image may optionally be displayed adjacent to the modified coating image, as illustrated in FIGS. 3 and 4. Examples of a screen display include, but are not limited to, a digital display device such as a computer monitor, a PDA, a cell phone, a tablet computer, or a TV; an optical display device, such as a projector; a print display such as a printer; other display devices, or a combination thereof. The display can also be a dual functional display/data input device. One example of such dual functional device is a touch screen of a computer, a smart phone, a tablet computer, or a PDA. The display may be forwarded to a phone with a screen, so the person can hold the display next to the motor vehicle in yet another embodiment. In some embodiments, the person may be able to select how the images are displayed, and one or more than one display techniques may be utilized. The person may optionally repeat the process described above until the person feels the modified coating image 22 is a good match for the motor vehicle, and this may take several repetitions with varying color additive options.

Once a modified coating is accepted, the person may produce an updated coating composition with the modified color additive formulation, where the updated coating composition is an actual coating composition as opposed to the modified coating that is a theoretical coating composition used for displaying the modified coating image. The modified color additive formulation is mixed into the type of coating being utilized. The updated coating composition may optionally be tested to verify the match to the motor vehicle (or other article), where the uncured updated coating composition is cured to form a cured updated coating, and the cured updated coating is compared to the motor vehicle determine if there is a match. The person may then coat (i.e., paint) the motor vehicle (or other article) with the updated coating composition 190, and cure the updated coating composition to form the cured updated coating. As discussed previously, the starting coating is based on a specific type of coating composition, such as an aqueous polyurethane, where the fan deck, the starting color list provided by the computer, the OEM color list, or other technique that is used for selecting the starting coating is based on that specific type of coating. The modified coating and consequently the updated coating composition are also based on the same type of coating as the starting coating. Therefore, the modified color additive formulation allows for production of the updated coating composition in part because the type of coating is known based on the starting coating.

The techniques, methods, and systems described herein provide a person the ability to view modifications to a coating's color without the need for specialized imaging devices and associated color matching software, and without the need to prepare actual samples of coatings with modified colors. This can simplify the color matching process at an affordable price point.

What is claimed is:

1. A method of displaying a modified coating image, the method comprising the steps of:
entering a starting coating into a computer with an input device, wherein the computer comprises the input device, a memory, a processor, and an output device, and wherein a person enters the starting coating into the computer;
providing a starting color additive formulation for the starting coating by the computer, wherein the starting color additive formulation comprises a starting color additive and a starting color additive quantity;
entering a modified color additive formulation into the computer, wherein the modified color additive formulation is different than the starting color additive formulation;
generating the modified coating image by the computer, where the modified coating image is generated based on the modified color additive formulation; and
displaying the modified coating image on the output device by the computer.

2. The method of claim 1, wherein the modified coating image comprises a depiction of the modified coating in three dimensions.

3. The method of claim 1, wherein displaying the modified coating image comprises displaying a target component of a target motor vehicle in 3 dimensions, where the target component is coated with a modified coating that corresponds to the modified color additive formulation.

4. The method of claim 1, further comprising:
imaging a test coating with an imaging device to create a test coating image;
measuring color data for the test coating;
repeating the imaging of the test coating and the measuring color data of the test coating to produce a library of test coatings; and wherein
generating the modified coating image comprises utilizing the library of test coatings.

5. A method of producing a modified coating, comprising:
selecting a modified coating based on the modified coating image displayed according to the method of claim 1;
producing an updated coating composition corresponding to the modified coating, wherein the updated coating composition comprises the modified color additive formulation to give the updated coating composition an appearance corresponding to the modified coating image.

6. A method of coating a motor vehicle, comprising:
producing the updated coating composition according to claim 5; and
coating at least a portion of the motor vehicle with the modified coating.

7. The method of claim 1, further comprising:
choosing the starting coating prior to entering the starting coating into the computer.

8. The method of claim 7, wherein choosing the starting coating comprises choosing the starting coating from a fan deck.

9. The method of claim 7, wherein choosing the starting coating comprises:
providing a starting coating list, wherein the computer provides the starting coating list; and
choosing the starting coating from the starting coating list.

10. The method of claim 7, wherein choosing the starting coating comprises:
choosing a target motor vehicle by the person;
providing an OEM coating color list by the computer, wherein the OEM coating color list is specific to the target motor vehicle; and
choosing the starting coating from the OEM coating color list.

11. The method of claim 1, wherein displaying the modified coating image further comprises displaying the modified coating image at a plurality of different viewing angles, wherein each of the plurality of different viewing angles is displayed in two dimensions.

12. The method of claim 1, wherein:
displaying the modified coating image comprises printing the modified coating image on a piece of paper.

13. The method of claim 1, further comprising:
retrieving a starting coating image from the memory by the computer; and
displaying the starting coating image with the modified coating image on the output device.

14. The method of claim 1, wherein:
the modified color additive formulation comprises an updated color additive that is absent from the starting color additive formulation.

15. The method of claim 1, wherein:
the modified color additive formulation comprises an updated color additive that is selected from the starting color additive formulation.

16. A system for displaying a modified coating image, comprising:
a computer, wherein the computer comprises a processor, an input device, an output device, and a memory, and wherein the processor operates a computer program, wherein the computer program is saved on a tangible memory device, wherein the computer program is configured to:
accept a starting coating from the input device;
provide a starting color additive formulation, wherein the starting color additive formulation is associated with the starting coating, and wherein the starting color additive formulation comprises a starting color additive and a starting color additive quantity;
accept a modified color additive formulation from the input device, wherein the modified color additive formulation is different than the starting color additive formulation;
generate the modified coating image, where the modified coating image is generated based on the modified color additive formulation; and
display the modified coating image on the output device.

17. The system of claim 16, wherein:
displaying the modified coating image further comprises displaying the modified coating image in three dimensions.

18. The system of claim 16, further comprising:
displaying a starting coating image with the modified coating image, wherein the starting coating image corresponds to the starting coating.

19. The system of claim 16, wherein:
The input device is selected from the group consisting of a keyboard, a mouse, a touchscreen, a microphone, and a combination thereof.

20. A method of displaying a modified coating image, the method comprising the steps of:
providing a starting coating list, wherein a computer provides the starting coating list, and wherein the computer comprises a processor, an input device, a memory, and an output device;
choosing a starting coating from the starting coating list, wherein a person chooses the starting coating from the starting coating list;
entering the starting coating into the computer with the input device by the person, and wherein the input device is selected from group consisting of a keyboard, a mouse, a touchscreen, a microphone, and a combination thereof;
providing a starting color additive formulation for the starting coating by the computer, wherein the starting color additive formulation comprises a starting color additive and a starting color additive quantity;
entering a modified color additive formulation into the computer with the input device, wherein the modified color additive formulation is different than the starting color additive formulation;
retrieving a starting coating image from the memory by the computer, wherein the starting coating image corresponds to the starting coating;
generating the modified coating image by the computer, where the modified coating image is generated based on the modified color additive formulation; and
displaying the starting coating image and the modified coating image in three dimensions on the output device.
